(19) United States
(12) Patent Application Publication
(10) Pub. No.: US 2025/0010449 A1
(43) Pub. Date: Jan. 9, 2025

(54) Control method for a rechargeable battery

(71) Applicant: Hilti Aktiengesellschaft, Schaan (LI)

(72) Inventors: Mathias FRENZEL, Unterdießen (DE); David KOSCHECK, Landsberg (DE); Klaus HAUSER, Schwabmünchen (DE); Stefan MAYER, Fensterbach (DE); Andreas GUGGEMOS, Bad Wörishofen (DE); Franz MÖSSNANG, Stadtbergen (DE)

(21) Appl. No.: 18/705,795

(22) PCT Filed: Nov. 10, 2022
(86) PCT No.: PCT/EP2022/081447

§ 371 Date: Apr. 29, 2024

(30) Foreign Application Priority Data
Dec. 1, 2021 (EP) 21211576.0

(51) Int. Cl. B25F 5/00; H02J 7/00

(52) U.S. Cl. CPC B25F 5/00; H02J 7/00034; H02J 7/007182

(57) ABSTRACT

Control method for a rechargeable battery that has an interface for communicating with a handheld power tool and for supplying power to the handheld power tool, wherein a machine characteristic value characterizing the handheld power tool is received via the interface of the rechargeable battery, the machine characteristic value representing at least one physical property of the handheld power tool, and the rechargeable battery being activated to deliver electrical energy to the handheld power tool if a logic circuit of the rechargeable battery determines that a system characteristic value, which is based on the machine characteristic value and on a rechargeable battery characteristic value representing a physical property of the rechargeable battery, exceeds or falls short of a predefined safety threshold.

The present invention relates to a control method for a rechargeable battery that has an interface for communicating with a handheld power tool and for supplying the handheld power tool with electrical energy, wherein a characteristic value characterizing the handheld power tool is received via the interface of the rechargeable battery.

### BACKGROUND

Such a control method is known, for example, from EP 2 207 249 B1. It is the object of the present invention to provide a control method for a rechargeable battery that creates the basis for increased protection against possible damage as a result of the rechargeable battery falling.

### SUMMARY OF THE INVENTION

The present invention provides that the machine characteristic value represents at least one physical property of the handheld power tool, and in that the rechargeable battery is activated to deliver electrical energy to the handheld power tool and/or the handheld power tool is adjusted from a first predetermined operating state to a second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state if a logic circuit of the rechargeable battery determines that a system characteristic value, which is based on the machine characteristic value and on a rechargeable battery characteristic value representing a physical property of the rechargeable battery, exceeds or falls short of a predefined safety threshold.

The invention encompasses the finding that a rechargeable battery for an electric handheld power tool (e.g. a rotary hammer) is a safety-critical component that-advantageously depending on whether a system characteristic value exceeds or falls short of a predefined safety threshold—is activated to deliver electrical energy, or actually allows the handheld power tool to draw electrical energy from the rechargeable battery. One application is, for example, protecting the rechargeable battery from possible damage as a result of a fall. In other words: there can be provision in particular for the rechargeable battery to be activated only when and/or only if it is used on a suitable handheld power tool, e.g. a handheld power tool that does not exceed a specific mass. An unsuitable rechargeable battery would not be used and would consequently be protected from possible damage or defects as a result of a fall.

The adjustment of the handheld power tool from the first to the second predetermined operating state, with no energy being able to be drawn from the rechargeable battery in the first operating state and energy being able to be drawn from the rechargeable battery in the second operating state, takes place after the rechargeable battery has transmitted an appropriate signal to the handheld power tool.

In this context, the term “discharge parameter” refers to a characteristic value, or characteristic, of a discharge process and includes, among other things, a current intensity value (i.e. discharge current), a voltage value (i.e. discharge voltage), a temperature value (i.e. maximum and/or minimum temperature limit values for carrying out a discharge process), a resistance value (i.e. maximum resistance limit values for carrying out a discharge process), or the like.

It has been found to be advantageous if the safety threshold is a predefined maximum fall energy of the rechargeable battery. In a further particularly preferred embodiment, the system characteristic value is a determined fall energy of a system comprising the handheld power tool and the rechargeable battery.

It has been found to be advantageous if the rechargeable battery is activated to deliver electrical energy to the handheld power tool and/or the handheld power tool is adjusted from a first predetermined operating state to a second predetermined operating state, the handheld power tool being able to draw no electrical energy from the rechargeable battery in the first predetermined operating state and being able to draw electrical energy with at least one predetermined charging parameter from the rechargeable battery in the second predetermined operating state if the system characteristic value falls short of the predefined safety threshold.

In a further particularly preferred refinement, the machine characteristic value comprises a mass of the handheld power tool. It has been found to be advantageous if the machine characteristic value comprises a predefined drop height of the handheld power tool. The machine characteristic value can comprise (or be represented by) a table, the table being able to be sent from the handheld power tool to the interface of the rechargeable battery in the manner of a telegram.

The table can have one or more table columns, each table column preferably being defined by one byte.

In a particularly preferred embodiment, the rechargeable battery characteristic value comprises a mass of the rechargeable battery. The rechargeable battery characteristic value can comprise (or be represented by) a table. The table can have one or more table columns, each table column preferably being defined by one byte.

It has been found to be advantageous if the system characteristic value is calculated from the sum of the mass of the rechargeable battery and the mass of the handheld power tool, multiplied by the predefined drop height of the handheld power tool and acceleration due to gravity.

It has been found to be advantageous if the control method contains a matching algorithm between the rechargeable battery and the handheld power tool.

It has been found to be advantageous that a voltage class of the rechargeable battery is sent to the handheld power tool via the interface when the control method is carried out and/or as part of the matching algorithm. The voltage class of the rechargeable battery can be 12 volts, 22 volts or 36 volts, for example.

In a further particularly preferred embodiment, the logic circuit checks at least one further technical condition as a prerequisite for the rechargeable battery being activated to deliver electrical energy to the handheld power tool and/or the handheld power tool being adjusted from the first predetermined operating state to the second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state.

Such a technical condition can, for example, be the correct voltage class of the rechargeable battery, i.e. a voltage class that is suited to the handheld power tool. Alternatively or additionally, such a technical condition can be, for example, a number of falls experienced by the rechargeable battery, if necessary weighted by the severity of a respective fall.

It is also possible for the logic circuit to continuously check at least one further technical condition, at regular or irregular intervals of time during a discharge process, as a prerequisite for the rechargeable battery being activated to deliver electrical energy to the handheld power tool and/or the handheld power tool being adjusted from the first predetermined operating state to the second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state. If the result of the check on the at least one further technical condition by the logic circuit is that there is not a sufficient match, the rechargeable battery is not activated or deactivated for delivering electrical energy to the handheld power tool. In addition, the handheld power tool remains in the first predetermined operating state or is adjusted back from the second to the first operating state.

The present invention also provides a rechargeable battery for an electric handheld power tool, the rechargeable battery having an interface for communicating with the handheld power tool and for supplying the handheld power tool with electrical energy. The interface is designed to receive a machine characteristic value that characterizes the handheld power tool and represents at least one physical property of the electric handheld power tool. The rechargeable battery is designed to be activated to deliver electrical energy to the handheld power tool and/or to transmit at least one signal to the handheld power tool in order to adjust the handheld power tool from a first predetermined operating state to a second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state if a logic circuit of the rechargeable battery determines that a system characteristic value, which is based on the machine characteristic value and on a rechargeable battery characteristic value representing a physical property of the rechargeable battery, exceeds or falls short of a predefined safety threshold.

The rechargeable battery may be developed as appropriate by the features described for the control method.

### BRIEF DESCRIPTION OF THE DRAWINGS

Further advantages will become apparent from the following description of the FIGURES. A particularly preferred exemplary embodiment of the present invention is depicted in the FIGURE. The FIGURES, the description and the claims contain numerous features in combination. A person skilled in the art will expediently also consider the features individually and combine them to form useful further combinations.

Identical and similar components are denoted by the same reference signs in the FIGURE, in which:

FIG. 1 shows a preferred exemplary embodiment of a rechargeable battery arranged on a handheld power tool.

### DETAILED DESCRIPTION

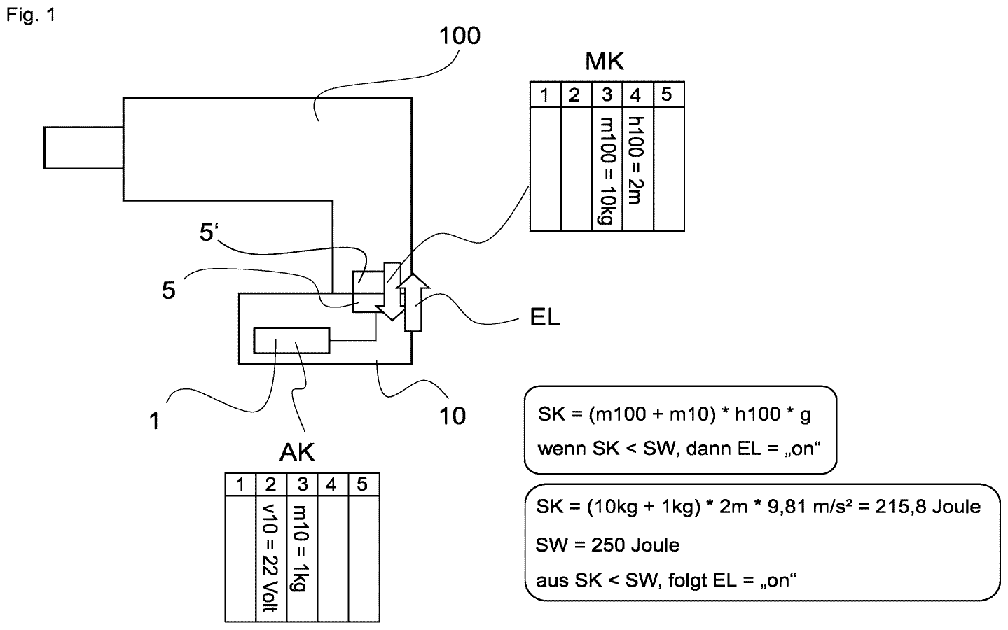

FIG. 1 shows—in a highly schematic representation-a rechargeable battery 10 for an electric handheld power tool 100.

The control method according to the invention is preferably implemented for the rechargeable battery 10 shown in FIG. 1.

The rechargeable battery 10 has a supply voltage of 22 volts by way of illustration. The rechargeable battery 10 is equipped with an interface 5 for communicating with the handheld power tool 100 and for supplying the handheld power tool 100 with electrical energy.

The handheld power tool 100 has a corresponding interface 5′, via which the handheld power tool 100 is in turn supplied with electrical energy by the rechargeable battery 10 and via which the handheld power tool 100 can establish a communicative connection to the rechargeable battery 10.

The interface 5 of the rechargeable battery 10 is designed to receive a machine characteristic value MK characterizing the handheld power tool 100 from the handheld power tool 100. By way of illustration, the machine characteristic value MK is shown as a table (also referred to as a look-up table), which is sent from the corresponding interface 5′ of the handheld power tool 100 to the interface 5 of the rechargeable battery 10 in the manner of a telegram. This can advantageously take place each time the rechargeable battery 10 (or another rechargeable battery) is connected to the handheld power tool 100.

In the present case, the machine characteristic value MK represents two physical properties of the handheld power tool 100, namely a mass m100 (here in table column 3) of the handheld power tool 100 and a predefined drop height h100 (here in table column 4) of the handheld power tool 100. By way of illustration, the mass m100 is 10 kilograms. The predefined drop height h100, that is to say in particular the maximum height from which the handheld power tool 100 can be expected to unintentionally fall during operation. The predefined drop height h100 is 2 meters here. The rechargeable battery characteristic value AK comprises a mass m10 (here in table column 3) of the rechargeable battery 10, which is 1 kilogram by way of illustration.

It has been found to be advantageous if the mass m100 of the handheld power tool 100 is stored in the machine characteristic value MK as a multiple of 200 grams (⅕ kg). The mass m10 (here in table column 2) of the rechargeable battery 10 is also advantageously stored in the rechargeable battery characteristic value as a multiple of 200 grams (⅕ kg). It has also been found to be advantageous if the predefined drop height h100 is stored in the machine characteristic value MK as a multiple of 10 centimeters ( 1/10 m). This allows a simplified calculation.

As can be seen from FIG. 1, the rechargeable battery 10 is equipped with a logic circuit 1 that can cause the rechargeable battery 10 to be activated to deliver electrical energy EL to the handheld power tool 100. This occurs if the logic circuit 1 of the rechargeable battery 10 determines that a system characteristic value SK, which is based on the machine characteristic value MK and a rechargeable battery characteristic value AK representing a physical property of the rechargeable battery 10, falls short of a predefined safety threshold SW. The activation of the rechargeable battery 10 to deliver electrical energy EL is shown in FIG. 1 by the status EL=“on”. The safety threshold SW is a predefined maximum fall energy of the rechargeable battery 10 and is 250 joules in the present example. The system characteristic value SK is a determined fall energy of a system comprising the handheld power tool 100 and the rechargeable battery 10. The system characteristic value SK is calculated from the sum of the mass m10 of the rechargeable battery 10 and the mass m100 of the handheld power tool 100 multiplied by the predefined drop height h100 of the handheld power tool 100 and acceleration due to gravity g, i.e. SK=(10 kg+1 kg)*2m*9.81 m/s²=215.8 joules.

Since the system characteristic value SK, at 215.8 joules, is lower than the safety threshold SW, the rechargeable battery 10 is activated to deliver electrical energy, i.e. EL=“on”. If the system characteristic value SK were greater than the safety threshold SW, the rechargeable battery 10 would remain inactive.

The control method implemented for the rechargeable battery 10 shown in FIG. 1 can be part of a matching algorithm between the rechargeable battery 10 and the handheld power tool 100. Put simply, the matching algorithm can be used to determine whether the rechargeable battery 10 (or another rechargeable battery that can be connected at least mechanically to the corresponding interface 5′ of the handheld power tool 100) is also actually suited to the handheld power tool 100.

The checking of the system characteristic value SK against the safety threshold SW that is presented in the context of this invention is therefore not necessarily the only technical criterion. There can thus be provision, for example, for the logic circuit 1 to check at least one further technical condition as a prerequisite for the rechargeable battery 10 being activated to deliver electrical energy EL to the handheld power tool 100. Such a further technical condition can be, for example, a voltage class v10 of the rechargeable battery 10, which is sent to the handheld power tool 100 via the interface 5. The rechargeable battery characteristic value AK can be extended by the voltage class v10 of the rechargeable battery 10, for example according to a telegram. Sequential evaluation of the rechargeable battery characteristic value AK in FIG. 1 would involve the voltage class v10, which can be found in table column 2, being processed first, followed by the mass m10 of the rechargeable battery 10, which can be found in table column 3.

### LIST OF REFERENCE SIGNS

1 Logic circuit
5 Interface
5′ Corresponding interface
10 Rechargeable battery
100 Electric handheld power tool
m10 Mass of the rechargeable battery
v10 Voltage class
m100 Mass of the handheld power tool
h100 Predefined drop height
AK Rechargeable battery characteristic value
EL Electrical energy
MK Machine characteristic value
SK System characteristic value
SW Safety threshold

What is claimed is:

1-10. (canceled)

11. A control method for a rechargeable battery having an interface for communicating with a handheld power tool and for supplying the handheld power tool with electrical energy, wherein a machine characteristic value characterizing the handheld power tool is received via the interface of the rechargeable battery, the machine characteristic value representing at least one physical property of the handheld power tool, the method comprising:
activating the rechargeable battery to deliver electrical energy to the handheld power tool or adjusting the handheld power tool from a first predetermined operating state to a second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state if a logic circuit if the rechargeable battery determines that a system characteristic value based on the machine characteristic value and on a rechargeable battery characteristic value representing a physical property of the rechargeable battery, exceeds or falls short of a predefined safety threshold.

12. The control method as recited in claim 11 wherein the safety threshold is a predefined maximum fall energy of the rechargeable battery.

13. The control method as recited in claim 11 wherein the system characteristic value is a determined fall energy of a system comprising the handheld power tool and the rechargeable battery.

14. The control method as recited in claim 11 wherein the machine characteristic value comprises a mass of the handheld power tool and a predefined drop height of the handheld power tool.

15. The control method as recited in claim 14 wherein the rechargeable battery characteristic value comprises a mass of the rechargeable battery.

16. The control method as recited in claim 15 wherein the system characteristic value is calculated from the sum of the mass of the rechargeable battery and the mass of the handheld power tool, multiplied by the predefined drop height (h100) of the handheld power tool and acceleration due to gravity.

17. The control method as recited in claim 11 wherein the control method contains a matching algorithm between the rechargeable battery and the handheld power tool.

18. The control method as recited in claim 16 wherein a voltage class of the rechargeable battery is sent to the handheld power tool via the interface when the control method is carried out or as part of the matching algorithm.

19. The control method as recited in claim 11 wherein the logic circuit checks at least one further technical condition as a prerequisite for the rechargeable battery being activated to deliver electrical energy to the handheld power tool or the handheld power tool (100) being adjusted from the first predetermined operating state to the second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state.

20. A rechargeable battery for an electric handheld power tool, the rechargeable battery comprising:
an interface for communicating with the handheld power tool and for supplying the handheld power tool with electrical energy, the interface being designed to receive a machine characteristic value characterizing the handheld power tool, the machine characteristic value representing at least one physical property of the handheld power tool, the rechargeable battery being designed to be activated to deliver electrical energy to the handheld power tool or to transmit at least one signal to the handheld power tool in order to adjust the handheld power tool from a first predetermined operating state to a second predetermined operating state, the handheld power tool being able to draw no electrical energy from the rechargeable battery in the first predetermined operating state and being able to draw electrical energy with at least one predetermined discharge parameter from the rechargeable battery in the second predetermined operating state if a logic circuit of the rechargeable battery determines that a system characteristic value based on the machine characteristic value and on a rechargeable battery characteristic value representing a physical property of the rechargeable battery, exceeds or falls short of a predefined safety threshold.

21. A system comprising the rechargeable battery as recited in claim 20 and an electric handheld power tool, the handheld power tool having a corresponding interface, the machine characteristic value characterizing the handheld power tool sendable to the interface of the rechargeable battery via the corresponding interface.
